(19) United States
(12) Patent Application Publication
(10) Pub. No.: US 2006/0090391 A1
(43) Pub. Date: May 4, 2006

(54) Structure of mosquito trapper

(76) Inventor: Shang-Lung Huang, Tai Chung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/038,214

(22) Filed: Jan. 21, 2005

(30) Foreign Application Priority Data
Oct. 29, 2004 (TW) 93217391

(51) Int. Cl. A01M 1/10; A01M 1/02

(52) U.S. Cl. 43/107

(57) ABSTRACT

A structure of a mosquito trapper has a container filled with predetermined water, a supporting flotation body, and a trapping mesh below the flotation body and with the flotation body. The supporting flotation body conforming to the inner periphery of the container floats on the water, and can rise or fall freely as the water level varies due to the water amount increasing or decreasing. The holes of the trapping mesh must be smaller than a grown mosquito and large enough to allow larvae to pass therethrough in the initial stage. The female mosquito is attracted to produce eggs on the water surface. After the eggs becoming larvae, the larvae will swim into the trapping mesh to grow. The grown mosquitoes can be trapped in the container by the trapping mesh and finally die.

### BACKGROUND OF THE INVENTION

1. Field of the Invention

This invention relates to a structure of mosquito trapper and particularly to a structure of mosquito trapper that is capable of trapping mosquitoes inside thereof so as to eradicate them without chemicals applied and external power supply.

2. Description of the Prior Art

Mosquito-borne diseases affect millions of people worldwide each year. For examples, there are 300-500 millions cases of malaria reported annually, resulting in 1.5 to 2.7 millions deaths. A female mosquito lays about 200 eggs each time and the eggs incubate quickly. Mosquitoes can propagate fast if we don't take any effective precautionary measures. Therefore, well mosquito control must be implemented to prevent mosquito-born disease spread.

There are various prevalent mosquito control devices currently, such as mosquito coil incense, electrical mosquito-repellent incense, mosquito-repellent liquid, and high-voltage mosquito capturing devices. Among them, many are potentially harmful and life-threatening in terms of safety and environmental protection, and should operate with chemicals applied or external power supply. On the other hand, some of them show only limited success in mosquito control due to being designed for repelling mosquitoes only, not to mention eradicating mosquitoes in large scale.

A conventional mosquito trapper comprises a container, an isolating mesh, and a net tray. The container has an open end and an amount of water. The isolating mesh is tightly coupled to the open end of the container, and a frame body is associated with the isolating mesh at the center thereof. The frame body is coupled together with the container. The net tray floats on water surface. A flange of the frame body abuts against a stopper flange of the mesh tray, whereby the mesh tray is not allowed to fall any further below the frame body. Female mosquitoes may be attracted to lay eggs on the net tray. When eggs, afterwards, become larvae in a couple of days later, larvae will swim into the isolating mesh to grow. When fully grown mosquitoes are formed, they will be trapped in the isolating mesh and cannot fly off. Finally, the mosquitoes die in the container at the end of their lifetime. However, the conventional mosquito trapper described above is provided with the container, the isolating mesh, and the net tray as members, and the isolation mesh must be tightly joined together with the open end of the container, and the frame body is associated with the isolating mesh at the center thereof. Obviously, the entire structure is complex and consisted of more superfluous elements, and needs sophisticated assembling processes accordingly. In addition, the water level will fall as the amount of water in the container decreases due to evaporation. When the water level falls below the surface of the mesh, the conventional mosquito trapper will fail and need maintenance of water refill. In the meantime, the mesh tray is staying at the lowest position and there still remains plenty of unwanted water in the container. In terms of cost-efficiency, the container is unnecessarily over designed.

Accordingly, there is an urgent need to have an effective mosquito control apparatus compliant with safety and environmental protection, which can work with less emergency consumption and less maintenance.

### SUMMARY OF THE INVENTION

This invention is mainly to provide a structure of a mosquito trapper that traps mosquitoes inside, and brought into the design concepts of mosquito's four stages in life cycle and female mosquito's behavior of laying eggs. The mosquito trapper, capable of eradicating mosquitoes, can operate without any chemicals applied, external power supply or frequented maintenance.

In order to achieve the object mentioned above, this invention provides a structure of a mosquito trapper, comprising a container filled with water, and a supporting flotation body floating on the water and conforming to the inner periphery of the container. In addition, the supporting floatation body is capable of rising or falling freely as the water level varies due to the water amount increasing or decreasing. A hollow portion is formed inside the flotation body. A trapping mesh is located below the flotation body and connected with the flotation body, wherein the holes of mesh are smaller than a grown mosquito and large enough to allow larvae to pass therethrough in the initial stage. The mosquito trapper provides longer period of use than the prior art does because the trapping mesh of this invention always keeps at a predetermined distance from the water surface, and is capable of rising or falling freely as water level varies. This invention traps mosquitoes in the container so that the mosquitoes cannot fly off to feed on the blood of humans.

In order to further know the features and technical means of this invention, reference is made to the detailed description according to this invention accompanied with drawings; however, the accompanied drawings are provided for reference and illustration only and are not limited to this invention.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is an exploded view of the present invention;

FIG. 2 is a 3D assembly drawing of the present invention;

FIG. 3 is a sectional view of the present invention; and

FIG. 4 is a 3D exploded view of another embodiment of the present invention.

### DETAILED DESCRIPTION OF THE INVENTION

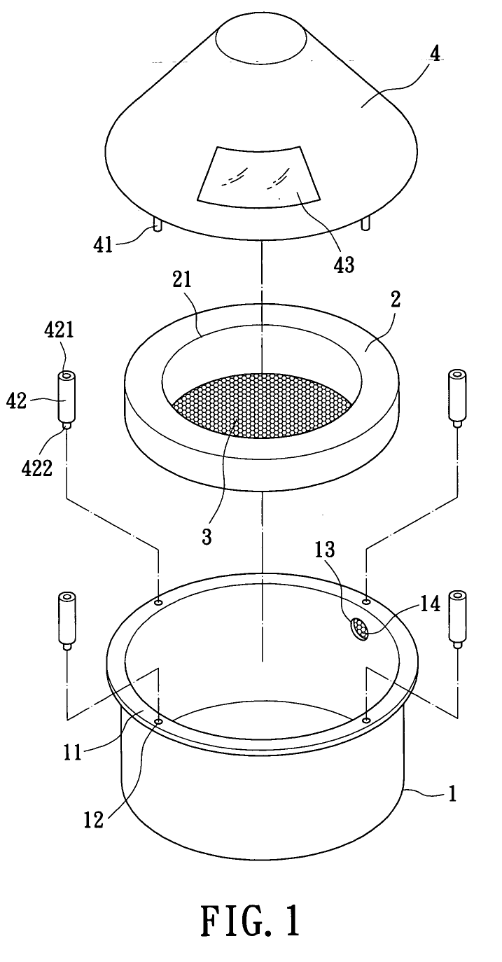

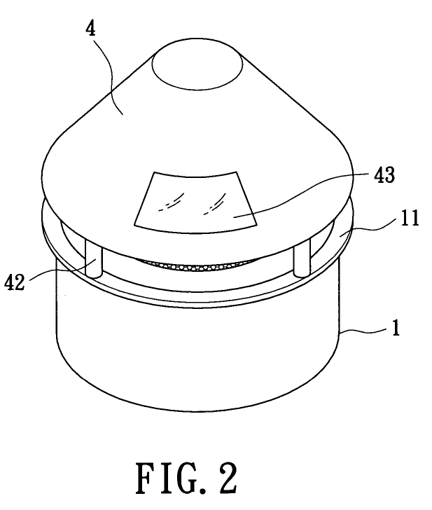

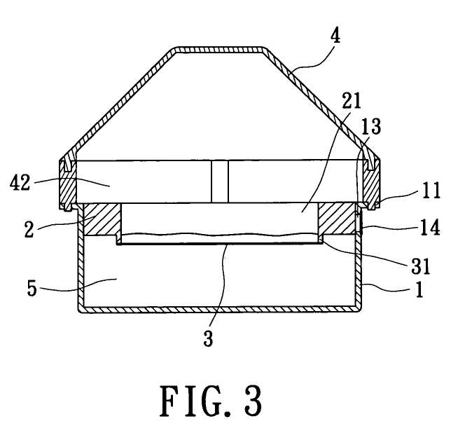

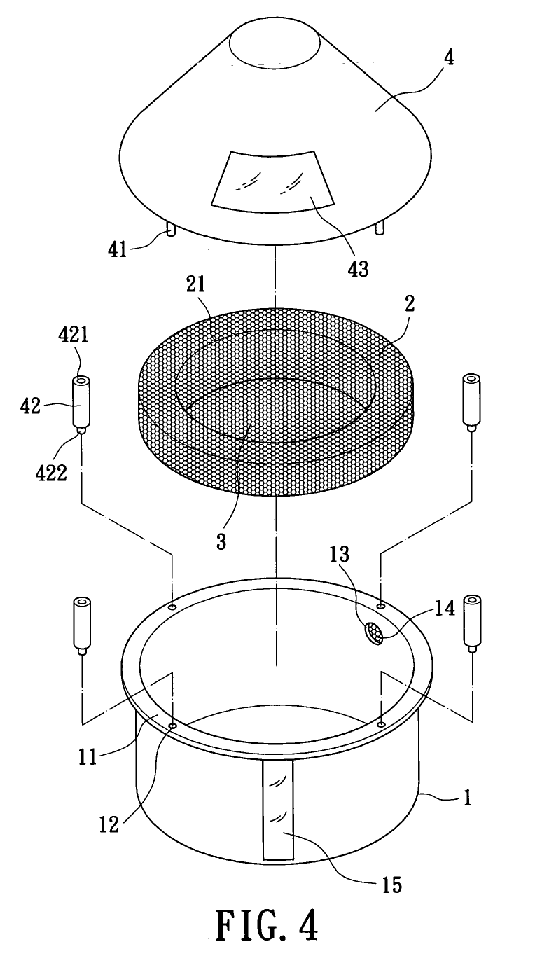

Referring now to FIGS. 1, 2, and 3, this invention provides a structure of a mosquito trapper, comprising a container 1, a supporting flotation body 2, a trapping mesh 3, and a top cover 4. The container 1 is a hollow housing body, a top of which is formed with an open end and a shape of the container 1 is not limited as long as water 5 can be stored inside of the container 1. In an embodiment, the container 1 is a round hollow housing body, the edge the of open end on the top of the container 1 is formed with a flange 11 extending outward, and a plurality of first joint holes 12 are provided respectively on the flange 11. A sidewall of the container 1 is provided with a draining hole 13 located with a filtering mesh 14 to allow excessive water flow through. The filtering mesh 14 serves to prevent the larvae or imagoes from flowing out of the draining hole 13 or flying off. Part of the container 1 may also be made of a transparent material to form a water level window 15 (shown in FIG. 4) for the purpose of observing the water level.

The supporting flotation body 2 floats on the water 5, and is made of a buoyant material. The supporting flotation body 2 conforming to the inner periphery of the container 1 can rise or fall freely as the water level varies. The interior of supporting flotation body 2 is formed with a hollow portion 21 so that mosquitoes may lay eggs on the water surface through the hollow portion 21. The supporting flotation body 2 is also made of a mesh material (the holes of the mesh material must be smaller than a grown mosquito and large enough to allow larvae to pass therethrough in the initial stage) (shown in FIG. 4) in a hollow torus.

The trapping mesh 3 is located below the supporting flotation body 2. The trapping mesh 3 can fit in the hollow portion of the supporting flotation body 2, the trapping mesh 3 is connected to the supporting flotation body 2 through a circular connection part 31; namely, the exterior of trapping mesh 3 is connected to the bottom of hollow portion 21 of the supporting flotation body 2 through the connection part 31, and the trapping mesh 3 can stay in the water 5 and always keeps at a predetermined distance from the water surface, along with the supporting flotation body 2. The connection part 31 can be either a sealed or a meshed plate. The holes of the trapping mesh 3 must be smaller than a grown mosquito and large enough to allow larvae to pass therethrough in the initial stage.

The top cover 4 is located above the container 1. The top cover 4 is a coniform hollow cover body. The outer diameter of top cover 4 is larger than that of container 1 so that the top cover 4 certainly covers the container 1. The inner side of top cover 4 protrudes with a plurality of first joint bodies 41, and part of the top cover 4 is made of a transparent material to form a water level window 43 for the purpose of observing the water level. A plurality of joint columns 42 are located between the top cover 4 and the container 1, and upper ends and lower ends of the joint columns 42 are respectively formed with second joint holes 421 and second joint bodies 422 to connect to the top cover 4 and the container 1.

The joint columns 42 are aligned correspondingly with first joint holes 12 on the flange 11 of the container 1 through the second joint bodies 422 at the lower ends so that the lower ends of the joint columns 42 may be detachably connected to the container 1. The joint columns 42 are inserted into the first joint bodies 41 of the inner side of top cover 4 through the second joint holes 421 at the upper ends so that the upper ends of the joint columns 42 are detachably connected to the top cover 4. The top cover 4 is detachably located on the container 1, the supporting flotation body 2, and the trapping mesh 3. The structure of the mosquito trapper according to the present invention is thus formed.

This invention for trapping mosquitoes utilizes mosquito's life cycle and female mosquito's behavior of laying eggs. Mosquitoes go through four stages in life cycle: egg, larva, pupa and adult. Female mosquitoes have a favorite behavior of laying eggs on clean, stagnant, and dim or dark water surface. When the container 1 is filled with water, the trapping mesh 3 can stay in the water 5 and always keeps at a predetermined distance from the water surface, along with the supporting flotation body 2. Further, the top cover 4 placed above the trapping mesh 3 provides shade to generate a dark environment. Female mosquitoes are attracted to lay eggs on the water surface of the container 1. After hatching from the eggs, larvae grow above the trapping mesh 3 in the water 5, periodically stretching their breathing organs out of the water surface to breathe. As the larvae gradually grow into bigger ones, larvae perceive the depth of the water 5 insufficient to provide the protection, thus larvae will swim through the trapping mesh for more water protection. During the period of that time, larvae still stretch their breathing organs out of the water surface to breath. As the larvae become bigger than the holes of the trapping mesh 3, the larvae are stranded in the trapping mesh 3 and forced to grow in the water 5. Subsequently, the larvae become pupae and then evolve into mosquitoes, the mosquitoes are trapped in the container 1 and can not fly off to feed on humans.

The structure according to this invention is greatly simplified and easily assembled. The flotation body 2 has excellent buoyancy per se and floats on the water, and can rise or fall freely as the water level varies. Further, the trapping mesh 3 and water surface always keeping at a predetermined distance from each other. Thus the mosquito trapper can provide longer period of use.

However, in the description mentioned above, only the preferred embodiments according to this invention are provided without limit to claims of this invention; all those skilled in the art without exception should include the equivalent changes and modifications as falling within the true scope and spirit of the present invention.

What is claimed is:

1. A structure of a mosquito trapper, comprising:
a container filled with water;
a supporting flotation body, wherein the supporting flotation body conforming to an inner periphery of the container floats on the water, thereby to rise or fall freely as the water level varies;
a hollow portion thereof being formed inside the supporting flotation body; and
a trapping mesh located below the supporting flotation body and connected with the supporting flotation body.

2. The structure of the mosquito trapper according to claim 1, wherein an open end is formed in a top of the container and a top cover is provided to cover the open end.

3. The structure of the mosquito trapper according to claim 2, wherein an edge of the open end of the container is formed with a flange, a plurality of first joint holes are provided respectively on predetermined positions of the flange, the inner side of top cover includes a plurality of first joint bodies protruding therefrom, a plurality of joint columns are located between the top cover and the container, upper ends and lower ends of the joint columns are respectively formed with second joint holes and second joint bodies, the joint columns are aligned with first joint holes through the second joint bodies at a lower end thereof, and the joint columns are inserted into the first joint bodies of the top cover through the second joint holes at upper ends thereof.

4. The structure of the mosquito trapper according to claim 2, wherein the top cover has a water level window.

5. The structure of the mosquito trapper according to claim 1, wherein a sidewall of the container is provided with a draining hole located with a filtering mesh.

6. The structure of mosquito trapper according to claim 1, wherein an exterior of the supporting flotation body stays close to an interior of the container.

7. The structure of the mosquito trapper according to claim 1, wherein an exterior of the trapping mesh is connected to a hollow portion of the supporting flotation body through an annular connection part.

8. The structure of the mosquito trapper according to claim 7, wherein the connection part is a sealed plate or a mesh plate.

9. The structure of the mosquito trapper according to claim 1, wherein the container has a water level window.

10. The structure of the mosquito trapper according to claim 1, wherein the supporting flotation body is made of a mesh material and the holes of mesh are smaller than a grown mosquito and large enough to allow larvae in an initial stage to pass therethrough.

11. The structure of the mosquito trapper according to claim 1, wherein the holes of the trapping mesh are smaller than a grown mosquito and large enough to allow larvae in an initial stage to pass therethrough.
